(19) United States
(12) Patent Application Publication
(10) Pub. No.: US 2026/0227925 A1
(43) Pub. Date: Aug. 6, 2026

(54) MEMORY CONTROLLER, STORAGE DEVICE, AND COMPUTER SYSTEM

(71) Applicant: Sony Group Corporation, Tokyo (JP)

(72) Inventor: Yuji Takahashi, Tokyo (JP)

(21) Appl. No.: 19/152,730

(22) PCT Filed: Jan. 22, 2024
(86) PCT No.: PCT/JP2024/001637

§ 371 Date: Jul. 31, 2025

(30) Foreign Application Priority Data
Mar. 15, 2023 (JP) 2023-040220

(51) Int. Cl. G06F 3/06

(52) U.S. Cl. CPC G06F 3/0655; G06F 3/0604; G06F 3/0673

(57) ABSTRACT

In a memory including a plurality of banks, access contention from a plurality of masters is reduced by considering attributes of the respective banks. In one example, a memory includes a banks each including pages. A memory controller includes an attribute information management unit and a control unit. The attribute information management unit manages an attribute determined on the basis of a mode in which each of the pages and banks in the memory is accessed by masters. The control unit moves any of pages among the banks on the basis of the attribute.

### TECHNICAL FIELD

The present technology relates to a storage device. Specifically, the present technology relates to a memory controller, a storage device, and a computer system that reduce access contention from a plurality of masters in a memory including a plurality of banks.

### BACKGROUND ART

In a memory accessed by a plurality of masters, there is known a memory in which a plurality of banks is provided to enable simultaneous operation to improve the overall throughput. However, in this case, if access is concentrated on the same bank from different masters, performance degradation occurs. Therefore, for example, a system has been proposed in which occurrence of access contention in a first memory bank is detected and remapping is performed to a second memory bank (See, for example, Patent Document 1.).

### CITATION LIST

### Patent Document

Patent Document 1: Japanese Translation of PCT International Application Publication No. 2020-511706

### SUMMARY OF THE INVENTION

### Problems to be Solved by the Invention

In the above-described conventional technique, a contention detector is provided, and remapping is performed between memory banks by detecting a contention that actually occurs during program operation. However, in a case where a memory including a plurality of banks is used by a plurality of masters, a contention itself can potentially occur, and in a case where data itself is shared, even if the data is moved each time of the contention, there is still a possibility that the contention occurs at a movement destination of the data. Consequently, the detection of the contention itself does not lead to an essential solution.

The present technology has been made in view of such a situation, and an object thereof is to reduce access contention from a plurality of masters by considering, in a memory including a plurality of banks, attributes of the respective banks.

### Solutions to Problems

The present technology has been made to solve the above-described problems, and a first aspect thereof is a memory controller, a storage device, and a computer system including: an attribute information management unit that manages an attribute determined on the basis of a mode in which, in a memory including a plurality of banks each including a plurality of pages, each of the plurality of pages and the plurality of banks is accessed by a plurality of masters; and
a control unit that moves any of the plurality of pages among the plurality of banks on the basis of the attribute. This brings about an effect of moving a page between the banks on the basis of attributes of the page and the bank.

Furthermore, in the first aspect, the attribute may include usage indicating whether each of the plurality of pages and the plurality of banks is a page or bank for shared use accessed by two or more of the plurality of masters or a page or bank for exclusive use accessed by only one of the plurality of masters, and the control unit may move any of the plurality of pages among the plurality of banks so that the usage matches between each of the plurality of pages and each of the plurality of banks. This brings about an effect that the page is moved between the banks so that the usage matches between the page and the bank.

Furthermore, in the first aspect, in a case where the usage of a specific page belonging to a specific bank in the plurality of banks indicates the shared use and the usage of the specific bank does not indicate the shared use, the control unit may move the specific page to another bank of which the usage indicates the shared use. This brings about an effect of moving the page for shared use to the bank for shared use.

Furthermore, in the first aspect, in a case where the usage of each of the plurality of pages and the plurality of banks indicates the exclusive use, the attribute may include a master identifier of a specific master that has accessed a page or bank last among the plurality of masters, and
in a case where the usage of a specific page belonging to a specific bank in the plurality of banks indicates the exclusive use and the usage of the specific bank does not indicate the exclusive use, the control unit may move the specific page to another bank of which the usage indicates the exclusive use and of which the master identifier matches the specific page. This brings about an effect that the page for exclusive use is moved to the bank for exclusive use with matching master identifier.

Furthermore, in the first aspect, each of the plurality of pages may include a plurality of words, the attribute may include a state indicating whether or not valid word data is stored for each of the plurality of words, and a master identifier indicating a specific master that has accessed the word data last among the plurality of masters in a case where the valid word data is stored, and when an access to a specific word in the plurality of words occurs, the attribute information management unit may update the state of the specific word and the master identifier. This brings about an effect that the state of the word and the master identifier are updated by using the access to the word as a trigger.

Furthermore, in the first aspect, when an access to a specific word in the plurality of words occurs, the attribute information management unit may update the attribute of a specific page to which the specific word belongs among the plurality of pages. This brings about an effect that the attribute of the page is updated by using the access to the word as a trigger.

Furthermore, in the first aspect, when an access to a specific word in the plurality of words occurs, in a case where the master identifier of each of all words storing valid word data among words included in a specific page to which the specific word belongs indicates the same master, the attribute information management unit may set the usage of the specific page to the exclusive use. This brings about an effect that the usage of the page in which the master identifier of each of all the words indicates the same master is set to the exclusive use by using the access to the word as a trigger.

Furthermore, in the first aspect, an initial value of the attribute of each of the plurality of pages and the plurality of banks may be the shared use.

Furthermore, in the first aspect, a setting register that sets upper limit values of a number of banks of which the usage indicates the shared use and a number of banks of which the usage indicates the exclusive use in the plurality of banks may be further included. This brings about an effect of setting the upper limit values of the bank for shared use and the bank for exclusive use from an external program or the like.

Furthermore, in the first aspect, a page conversion table that manages a movement destination page address of a page moved between the plurality of banks among the plurality of pages and performs page address conversion may be further included. This brings about an effect of specifying a physical page of the page moved on the basis of the attribute.

Furthermore, in the first aspect, a status register that is an interface that observes and changes the attribute may be further included. This brings about an effect of observing and changing the attribute from an external program or the like.

### BRIEF DESCRIPTION OF DRAWINGS

FIG. 1 is a diagram illustrating an example of a configuration of a computer system in an embodiment of the present technology.

FIG. 2 is a diagram illustrating a configuration example of a bank 310 of a memory 300 in the embodiment of the present technology.

FIG. 3 is a diagram illustrating a configuration example of a memory controller 200 in the embodiment of the present technology.

FIG. 4 is a diagram illustrating examples of contents of attributes related to the bank 310 and a page 320 in the embodiment of the present technology.

FIG. 5 is a diagram illustrating examples of contents of attributes related to a word 330 in the embodiment of the present technology.

FIG. 6 is a diagram illustrating specific examples of attributes related to the bank 310, the page 320, and the word 330 in the embodiment of the present technology.

FIG. 7 is a diagram illustrating an example of a page conversion table 220 in the embodiment of the present technology.

FIG. 8 is a flowchart illustrating an example of an operation algorithm of the computer system in the embodiment of the present technology.

FIG. 9 is a flowchart illustrating a processing procedure example of shared use page move processing (step S940) in the embodiment of the present technology.

FIG. 10 is a flowchart illustrating a processing procedure example of exclusive use page move processing (step S950) in the embodiment of the present technology.

### MODE FOR CARRYING OUT THE INVENTION

Modes for carrying out the present technology (hereinafter, referred to as embodiments) will be described below. The description will be given in the following order.
1. System Configuration
2. Operation algorithm

### 1. System Configuration

### Computer System

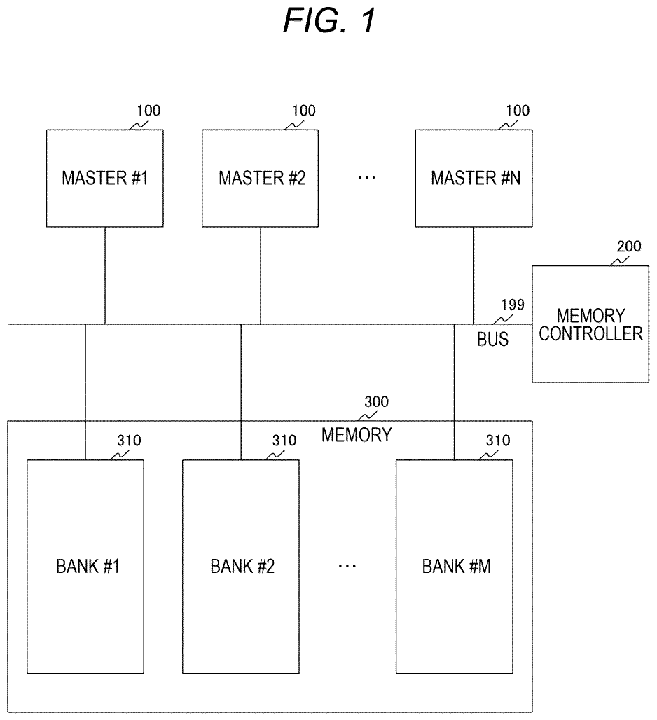

FIG. 1 is a diagram illustrating an example of a configuration of a computer system in an embodiment of the present technology.

The computer system includes N masters 100, a memory controller 200, and a memory 300. The memory 300 includes M banks 310. Note that N and M are each an integer greater than 1. The master 100, the memory controller 200, and the bank 310 are subjected to arbitration by a bus 199 and are connected to each other.

The master 100 is a device that accesses the memory 300, and for example, a processor is assumed. The N masters 100 may each access the M banks 310 of the memory 300 in parallel.

The memory controller 200 is a controller that controls an access from the master 100 to the memory 300. In this embodiment, the memory controller 200 manages arrangement of data in the memory 300 as described later.

Note that it is assumed that an access from each of the N masters 100 to the memory 300 can be executed out-of-order on the bus 199.

### Memory

The memory 300 is a storage device that stores data for the master 100. For example, programs, data, and the like necessary for the operation of the processor are assumed. The memory 300 includes M banks 310, each configured to be accessible in parallel. The M banks 310 only need to be able to operate independently, and the circuit configuration can be appropriately selected.

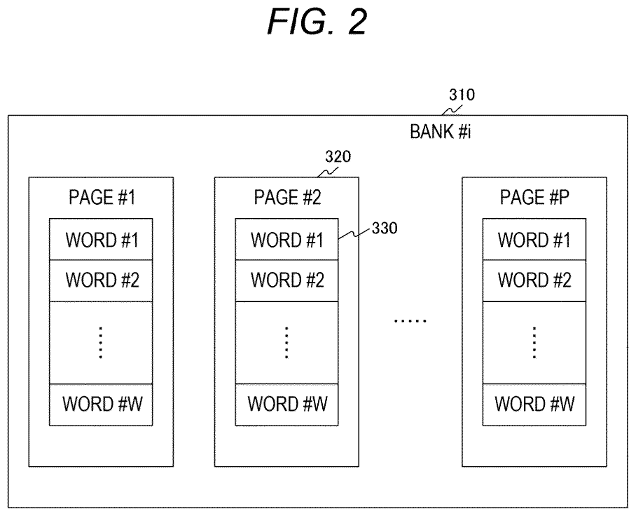

FIG. 2 is a diagram illustrating a configuration example of the bank 310 of the memory 300 in the embodiment of the present technology. Note that although an i-th bank #i is illustrated in the drawing, the other banks 310 have a similar configuration, and thus will be described below as the bank 310.

The bank 310 includes P pages 320. Furthermore, each of the pages 320 includes W words 330. Note that P is an integer greater than 1, and W is a positive integer.

The word 330 is a unit in which read or write access is performed from the master 100, and for example, data of 8 bytes or 16 bytes is assumed. The page 320 is a management unit of data arrangement by the memory controller 200.

### Memory Controller

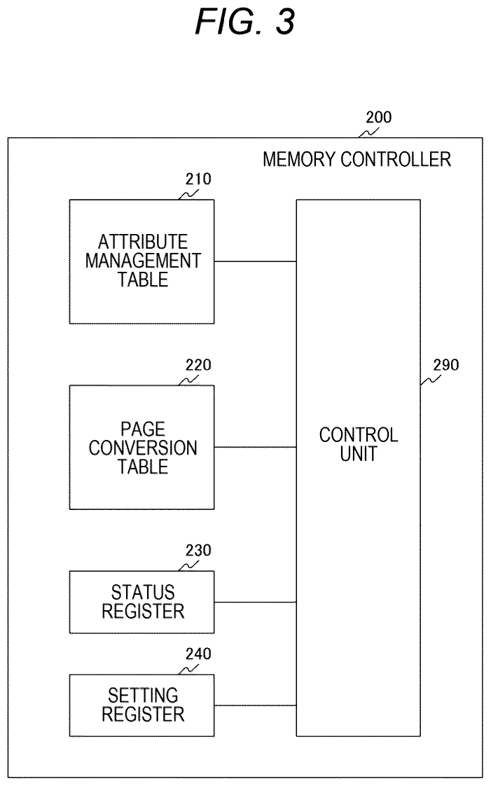

FIG. 3 is a diagram illustrating a configuration example of the memory controller 200 in the embodiment of the present technology.

The memory controller 200 includes an attribute management table 210, a page conversion table 220, a status register 230, a setting register 240, and a control unit 290.

The attribute management table 210 is a table that manages attributes of each of the bank 310, the page 320, and the word 330 of the memory 300. The memory controller 200 moves the page 320 between the banks 310 on the basis of the attribute managed in the attribute management table 210. Details of the attribute managed in the attribute management table 210 will be described later. Note that the attribute management table 210 is an example of an attribute information management unit recited in the claims.

The page conversion table 220 is a table for managing a movement destination page address when an arrangement address is changed with the movement of the page 320 and performing page address conversion. A configuration example of the page conversion table 220 will be described later.

The status register 230 is an interface for observing the attribute managed by the attribute management table 210 and changing the attribute. By using the status register 230, for example, the attribute can be finely adjusted from software according to the situation of the system.

The setting register 240 is a register for previously setting an upper limit value or the like of each attribute of the bank 310. The contents of the attribute for which the upper limit value is set will be described later.

The control unit 290 controls the entire operation of the memory controller 200. For example, the control unit 290 performs control for moving the page 320 between the banks 310 with reference to the attributes managed in the attribute management table 210. Furthermore, control is performed to manage a movement destination page address when the arrangement address is changed with the movement of the page 320 using the page conversion table 220. Furthermore, control of managing attributes in the attribute management table 210 is performed with reference to the status register 230 and the setting register 240.

Here, data transfer when the page 320 is moved between the banks 310 will be described. In a case where the page 320 is moved by the bus 199 by using direct memory access (DMA) transfer, it is first conceivable to perform transfer by using a normal data bus. In this case, a controller that issues a transfer instruction is mounted on a DMA controller for exclusive use or a general-purpose DMA controller. Secondly, it is conceivable to provide a bus for exclusive use for transfer. In this case, a DMA controller with a sequencer is provided in the bus for exclusive use. In the former case, the number of additional circuits is small, but the degree of access contention may be increased. In the latter case, data can be transferred without increasing access contention, but there is a problem that an additional circuit scale becomes relatively large. Consequently, it is necessary to perform system design in consideration of these trade-offs.

### Attribute

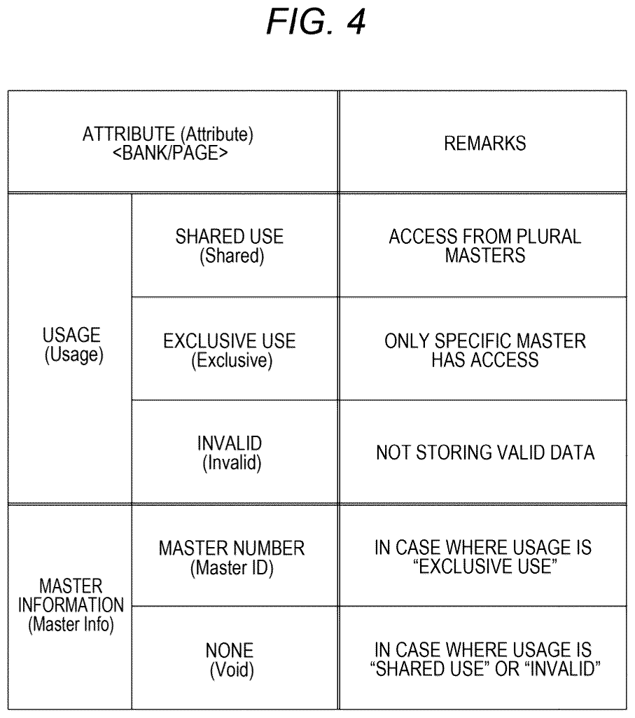

FIG. 4 is a diagram illustrating examples of contents of attributes related to the bank 310 and the page 320 in the embodiment of the present technology. The attribute (Attribute) relating to the bank 310 and the page 320 includes two attributes of usage (Usage) and master information (Master Info).

The usage as the first attribute indicates usage when the bank 310 and the page 320 are accessed by the master 100. As the usage, any one of three values of “shared use (Shared) ”, “exclusive use (Exclusive) ”, and “invalid (Invalid)” is indicated. “Shared use” indicates that the bank 310 or the page 320 is accessed by two or more masters 100. “Exclusive use” indicates that the bank 310 or the page 320 is exclusively accessed from one master 100. “Invalid” indicates that the bank 310 or the page 320 does not store valid data.

The master information as the second attribute indicates information regarding the master 100 using the bank 310 and the page 320. As the master information, one of two values of “master number (Master ID)” and “none (Void)” is indicated. “Master number” is an identifier of the master 100, and indicates the number of the master 100 that has accessed last in a case where the usage is the bank 310 or the page 320 indicating “exclusive use”. “None” means that there is no specific master 100 utilizing the bank 310 or the page 320, and will indicate this “none” in a case where the usage of the bank 310 or the page 320 is “shared use” or “invalid”.

The control unit 290 of the memory controller 200 moves the page 320 between the banks 310 so that the usage matches between the page 320 and the bank 310. That is, in a case where usage of the page 320 belonging to the bank 310 indicates “shared use” and the usage of the bank 310 does not indicate “shared use”, the control unit 290 moves the page 320 to another bank 310 of which usage indicates “shared use”. Furthermore, in a case where the usage of the page 320 belonging to the bank 310 indicates “exclusive use” and the usage of the bank 310 does not indicate “exclusive use”, the control unit 290 moves the page 320 to another bank 310 of which usage indicates “exclusive use” and of which master identifier matches the page 320. Therefore, the usages of the page 320 and the bank 310 coincide with each other, and the bank 310 that may cause contention can be grouped into the bank 310 of which usage indicates “shared use”. Consequently, in the bank 310 of which usage indicates “exclusive use”, it is possible to avoid a contention and avoid a decrease in performance.

The initial values of the usages of the bank 310 and the page 320 are “shared use”, a bank for “exclusive use” for a specific master is set as needed. The number of banks for “exclusive use” is not limited to one, and a plurality of banks may be set as banks for “exclusive use” of a specific master when one bank is full. However, an upper limit of the number of banks for “exclusive use” or banks for “shared use” can be set by the setting register 240.

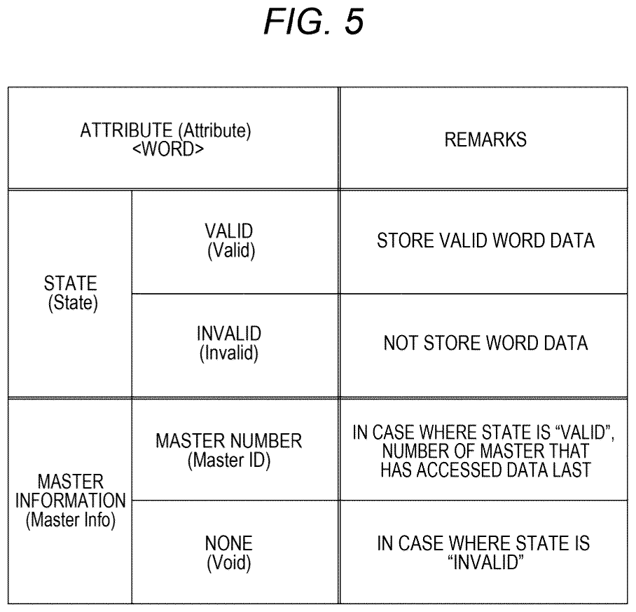

FIG. 5 is a diagram illustrating examples of contents of attributes related to the word 330 in the embodiment of the present technology. The attribute (Attribute) related to the word 330 includes two attributes of a state (State) and master information (Master Info).

The state that is the first attribute indicates one of two values of “valid (Valid) ” and “invalid (Invalid) ”. “Valid” indicates that the word 330 stores valid word data. “Invalid” indicates that the word 330 does not store valid word data.

The master information, which is the second attribute, indicates information regarding the master 100 that accesses the word 330. As the master information, one of two values of “master number (Master ID)” and “none (Void)” is indicated. “Master number” is an identifier of the master 100, and in a case where the state is the word 330 indicating “valid”, the “master number” indicates a number of the master 100 that has accessed last. “None” means that there is no specific master 100 using the word 330, and in a case where the state of the word 330 is “invalid”, this “none” is indicated.

When an access to the word 330 occurs, the attribute management table 210 updates the state and the master information of the word 330. That is, in a case where a new write access occurs in the word 330 whose state indicates “invalid”, the state is set to “valid” and the master information is set to “none”. Furthermore, in a case where the state of the word 330 is “valid” and an access from the master 100 different from the current master information occurs, the master information of the word 330 is updated to the number of the new master 100.

When an access to the word 330 occurs, the attribute management table 210 updates the state and the master information of the word 330 and updates the attribute of the page 320 to which the word 330 belongs. That is, when an access to the word 330 occurs, in a case where the master information of all the words storing valid word data among the words included in the page 320 to which the word 330 belongs indicates the same master 100, the attribute management table 210 sets the usage of the page 320 to “exclusive use” and sets the master information to the number of the master 100.

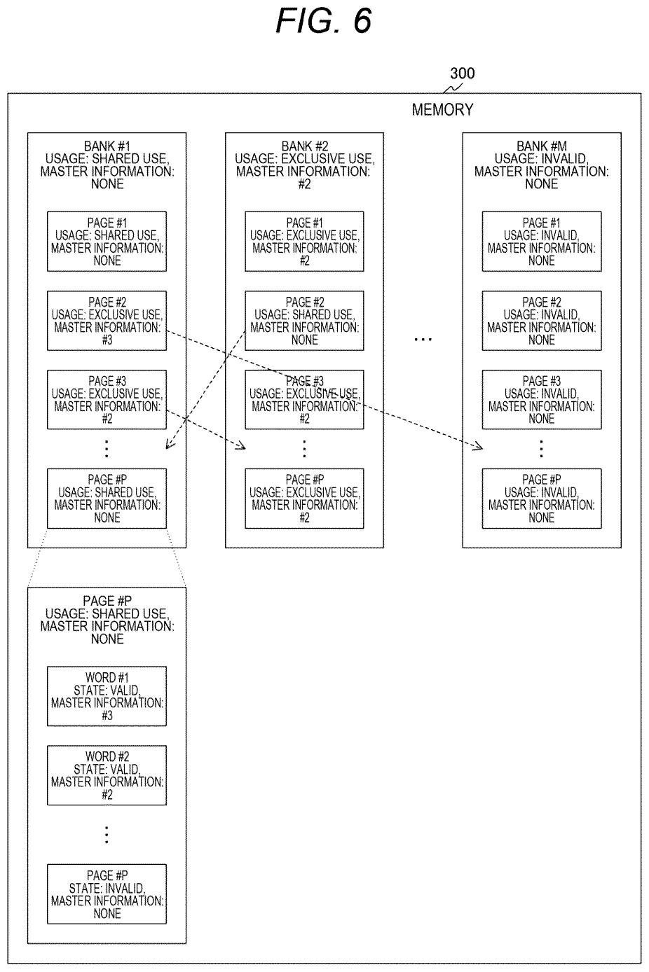

FIG. 6 is a diagram illustrating specific examples of attributes related to the bank 310, the page 320, and the word 330 in the embodiment of the present technology.

In this example, it is assumed that the bank #1 is a bank for “shared use”, the bank #2 is a bank for “exclusive” use” of the master #2, and the bank #M is an “invalid” bank.

Here, since the page #2 of the bank #2 is a page for “shared use”, the usage does not match that of the bank #2. Therefore, the control unit 290 moves the page #2 of the bank #2 to the bank #1. Therefore, the usage of the page 320 and the usage of the bank 310 match.

Furthermore, since the page #3 of the bank #1 is a page for “exclusive use” of the master #2, the usage of the page #3 does not match that of the bank #1. Therefore, the control unit 290 moves the page #3 of the bank #1 to the bank #2. Therefore, the usage and the master information of the page 320 and the bank 310 match.

Furthermore, since the page #2 of the bank #1 is a page for “exclusive use” of the master #3, the usage of the page #2 does not match that of the bank #1. Here, it is assumed that there is no other bank for “exclusive use” of the master #3, and it is assumed that the bank #M of which usage is “invalid” is newly used as a bank for “exclusive use” of the master #3. Therefore, the control unit 290 moves the page #2 of the bank #1 to the bank #M and sets the bank #M as the bank for “exclusive use” of the master #3. Therefore, the usage and the master information of the page 320 and the bank 310 match.

In this manner, the page 320 is moved between the banks 310 so that the usages are matched. Then, the usage of the bank is changed as necessary. At this time, upper limit values of the number of banks of which usage indicates “shared use” and the number of banks of which usage indicates “exclusive use” can be set by the setting register 240 described above. This may balance the number of banks for “exclusive use” and banks for “shared use”.

### Page Conversion Table

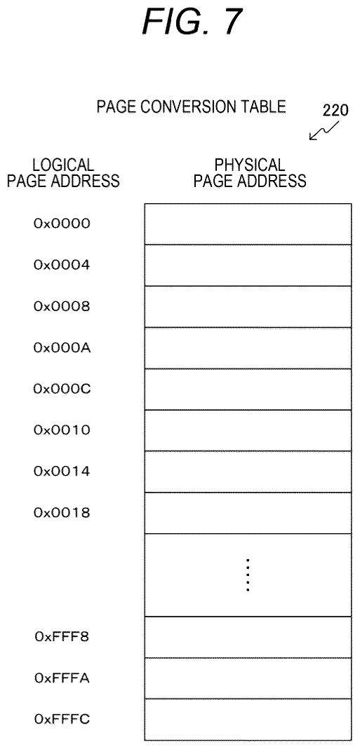

FIG. 7 is a diagram illustrating an example of the page conversion table 220 in the embodiment of the present technology.

The page conversion table 220 is a table for managing a movement destination page address when the arrangement address is changed with the movement of the page 320 and performing page address conversion. The page conversion table 220 holds the physical page address in the memory 300 in correspondence with the logical page address. That is, the page conversion table 220 holds a Correspondence relationship between an actual physical address of the page data rearranged with the movement of the page 320 and a logical address accessed from a program before the rearrangement. Therefore, when an access from the master 100 occurs, it is used when the logical address is converted into the physical address of the memory 300.

### 2. Operation Algorithm

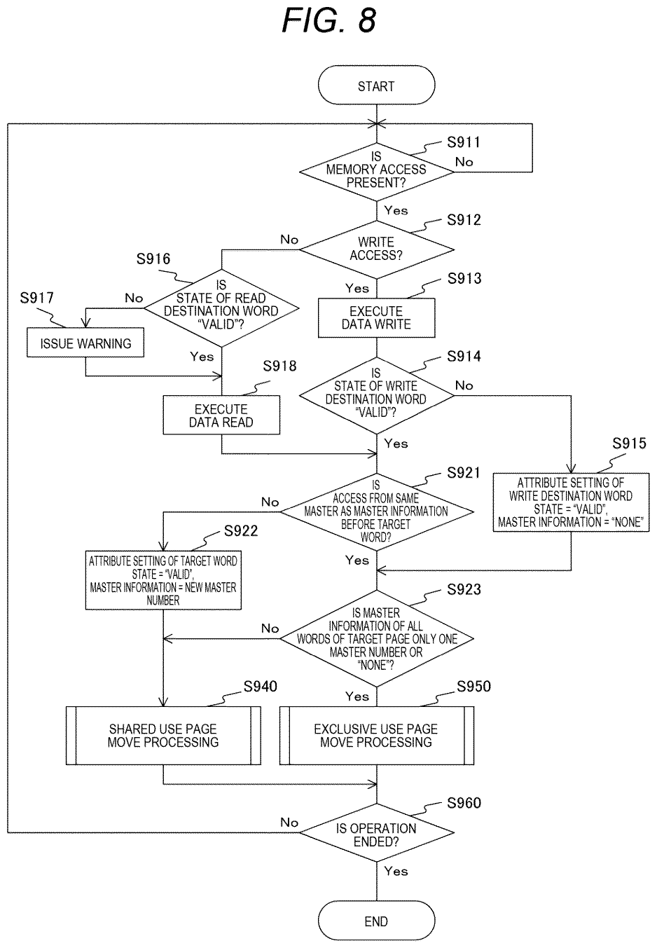

FIG. 8 is a flowchart illustrating an example of an operation algorithm of the computer system in the embodiment of the present technology.

When a write access occurs from the master 100 to the memory 300 (step S911: Yes, step S912: Yes), write data from the master 100 is written to the memory 300 (step S913). At this time, in a case where the state of the write destination word 330 does not indicate “valid” (step S914: No), the state of the write destination word 330 is set to “valid”, and the master information is set to “none” (step S915).

When a read access occurs from the master 100 to the memory 300 (step S911: Yes, step S912: No), data is read from the memory 300 (step 8918). At this time, if the state of the read destination word is not “valid” (step S916: No), a warning is issued (step S917).

In a case where the state of the word 330 of the write destination by the write access indicates “valid” (step 8914: Yes), or in a case where the read access is performed (step S912: No), if the access is not from the same master 100 as the master information before the word 330 (step S921: No), the state of the word 330 is “valid”, and the master information is set to the number of the new master 100 (step S922). In this case, it is assumed that the page 320 to which the word 330 belongs is “shared use”, and the shared use page move processing is performed (step S940).

On the other hand, in a case where the access is from the same master 100 as the master information before the word 330 (step S921: Yes), if the master information of all the words 330 in the page 320 to which the word 330 belongs includes only one master number or “none” (step S923: Yes), exclusive use page move processing is performed (step S950), and otherwise (step S923: No), the shared use page move processing is performed (step S940).

In this way, the page for “shared use” and the page “exclusive use” are distributed. The memory controller 200 repeats these processes until the operation is completed (step S960).

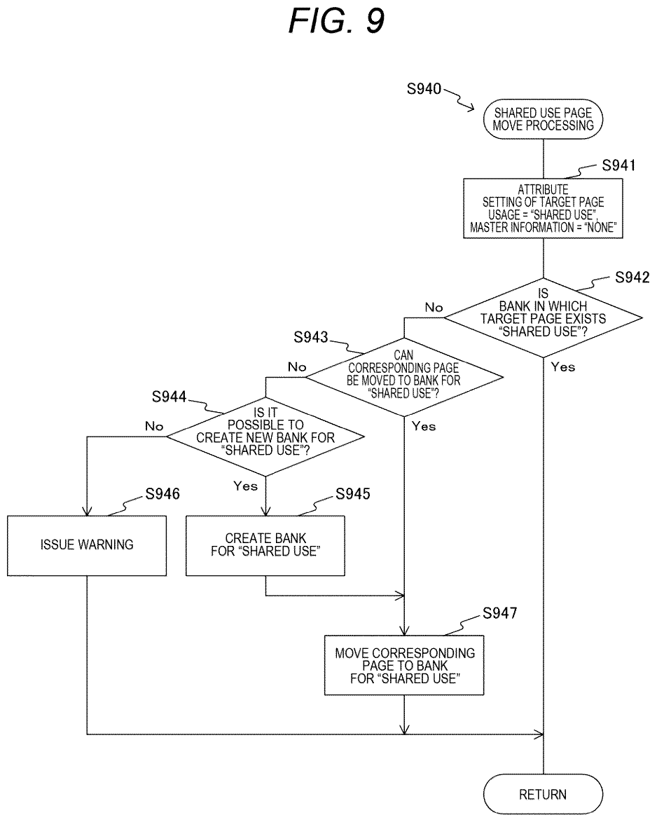

FIG. 9 is a flowchart illustrating a processing procedure example of the shared use page move processing (step S940) in the embodiment of the present technology.

In the shared use page move processing, first, the usage of the page 320 to which the word 330 belongs is set to “shared use”, and the master information is set to “none” (step S941). At this time, if the usage of the bank 310 in which the page exists is “shared use” (step S942: Yes), no further processing is necessary, and thus the shared use page move processing is ended.

In a case where the usage of the bank 310 in which the page 320 exists is not “shared use” (step S942: No), if the page 320 can be moved to another bank 310 of which £ usage indicates “shared use” (step S943: Yes), the movement is performed (step S947). On the other hand, if it is possible to newly create the bank 310 of which usage indicates “shared use” (step S944: Yes), such a bank for “shared use” is created (step $945), and the page 320 is moved to the bank for “shared use” (step S947). However, if it is not possible to newly create the bank 310 of which usage indicates “shared use” (step S944: No), a warning is issued (step S946), and the shared use page move processing is ended without performing movement.

As described above, in a case where the memory resource is insufficient by the system and a bank for “exclusive use” cannot be newly created, or in a case where there is no free space and data cannot be transferred, the transfer is abandoned, and a warning indicating that the transfer cannot be performed is issued, and the processing is ended. When a warning is issued, an interrupt may be generated to leave the address of a target page and the warning status in the status register 230.

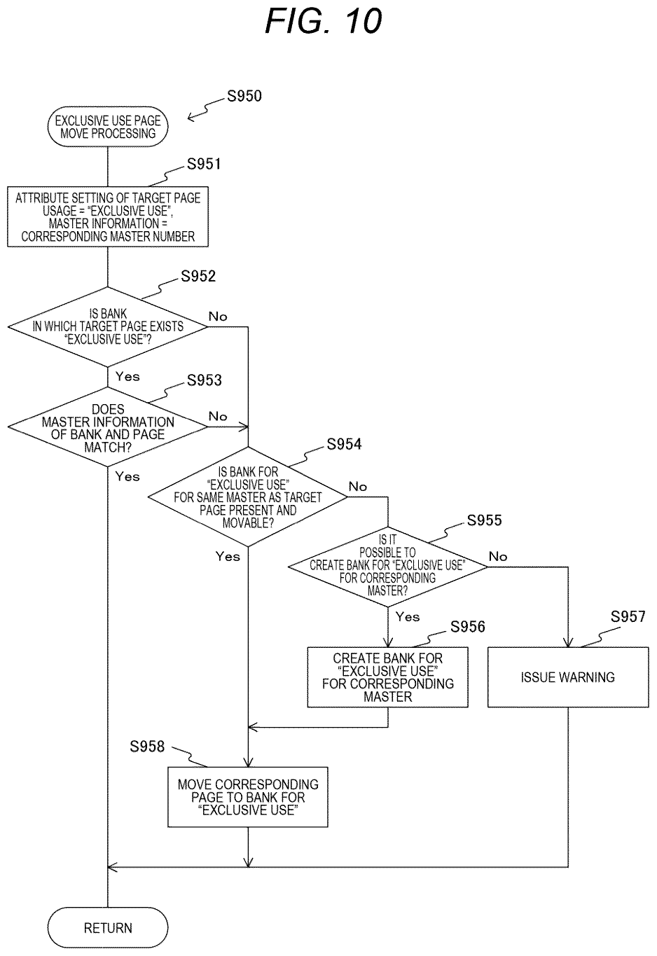

FIG. 10 is a flowchart illustrating a processing procedure example of the exclusive use page move processing (step S950) in the embodiment of the present technology.

In the exclusive use page move processing, first, the usage of the page 320 to which the word 330 belongs is set to “exclusive use”, and the number of the accessed master 100 is set to the master information (step S951). At this time, in a case where the usage of the bank 310 in which the page exists is “exclusive use” (step S952: Yes) and the master information of the bank 310 and the page 320 matches (step S953: Yes), no further processing is required, and thus the exclusive use page move processing is ended.

In a case where usage of the bank 310 in which the page exists is not “exclusive use” (step S952: No), or in a case where the master information of the bank 310 and the master information of the page 320 do not match (step S953: No), if another bank for “exclusive use” with the same master information exists and the bank can be moved to the bank for “exclusive use” (step S954: Yes), the bank is moved (step S958). On the other hand, if it is possible to newly create another bank for “exclusive use” with matching master information (step S955: Yes), such a bank for “exclusive use” is created (step S956), and the page 320 is moved to the bank for “exclusive use” (step S958). However, in a case where the bank 310 of which usage indicates “exclusive use” cannot be newly created (step S955: No), a warning is issued (step S957), and the exclusive use page move processing is ended without performing the movement.

In the above-described processing procedure, it is assumed that the master information is set to “none” when writing is performed on a page of which usage is “invalid” or a word of which state is “invalid”. This is because it is assumed that when a program or data is first placed in the memory, the program or the data is deployed to the memory from a processor for system control or an external memory, a ROM, or the like, and writing is not necessarily performed by a processor or the like that actually uses the data or the program. Note that, even in this initial operation, the master information may be left from the beginning by setting.

Furthermore, although not specifically mentioned in the processing procedure described above, in a case where a word of which state is “valid” is no longer used, a procedure for setting the state to “invalid” is required at any timing.

### Effects

As described above, in the embodiment of the present technology, in the memory 300 including the plurality of banks 310, the page 320 is moved between the banks 310 in consideration of the attributes of the respective banks 310 so that the usage matches. Therefore, access contention in the bank 310 from the plurality of masters 100 can be reduced.

Specifically, two masters, master A and master B, will be described as an example. It is assumed that only 20% of data is shared by the masters A and B while only one bank is used as in the related art. Then, it is assumed that 10% of the number of times of access from the masters A and B causes access contention. At this time, assuming that one of the masters A and B accesses 100 times in a unit time, contention occurs 10 times among them.

On the other hand, according to the embodiment of the present technology, it is assumed that a bank for exclusive use for the master A and a bank for exclusive use for the master B are set in each of the two separate banks 310, and 80% of the data in the memory 300 shared first is moved to each bank 310. Moreover, for simplicity, it is assumed that masters A and B access data equally. The first shared bank 310 is accessed 20 times per unit time, and the access contention is also 2 times, which is 10% of the number of times of the access. As described above, assuming the ideal and simple situation, the number of contentions at the time of memory access, which causes performance degradation, is ⅕.

Note that whether or not the functions according to the above-described embodiment are enabled may be dynamically switched in accordance with the needs of the system or the characteristics of the program. Furthermore, a specific bank or a specific page may be set as a non-rearrangement target. In order to realize these settings, the above-described setting register 240 can be used.

Note that the embodiments described above indicate examples for embodying the present technology, and the individual matters in the embodiments and the individual matters specifying the invention in the claims have correspondence relationships. Similarly, the respective matters specifying the invention in the claims and the respective matters with the same names in the embodiments of the present technology have correspondence relationships. However, the present technology is not limited to the embodiments, and can be embodied by applying various kinds of modification to the embodiments without departing from the scope of the present technology.

Furthermore, the procedures described in the above-described embodiments may be considered as a method including a series of procedures and may be considered as a program for allowing a computer to execute the series of procedures and a recording medium which stores the program. As this recording medium, for example, a compact disc (CD), a MiniDisc (MD), a digital versatile disc (DVD), a memory card, a Blu-ray® disc, and the like can be used.

Note that the effects described herein are merely examples and are not limited, and other effects may also be achieved.

Note that the present technology may also have the following configuration.
(1) A memory controller including:
an attribute information management unit that manages an attribute determined on the basis of a mode in which, in a memory including a plurality of banks each including a plurality of pages, each of the plurality of pages and the plurality of banks is accessed by a plurality of masters; and a control unit that moves any of the plurality of pages among the plurality of banks on the basis of the attribute.
(2) The memory controller according to (1) described above, in which
the attribute includes usage indicating whether each of the plurality of pages and the plurality of banks is a page or bank for shared use accessed by two or more of the plurality of masters or a page or bank for exclusive use accessed by only one of the plurality of masters, and
the control unit moves any of the plurality of pages among the plurality of banks so that the usage matches between each of the plurality of pages and each of the plurality of banks.
(3) The memory controller according to (2) described above, in which
in a case where the usage of a specific page belonging to a specific bank in the plurality of banks indicates the shared use and the usage of the specific bank does not indicate the shared use, the control unit moves the specific page to another bank of which the usage indicates the shared use.
(4) The memory controller according to (2) or (3) described above, in which
in a case where the usage of each of the plurality of pages and the plurality of banks indicates the exclusive use, the attribute includes a master identifier of a specific master that has accessed the page or bank last among the plurality of masters, and
in a case where the usage of a specific page belonging to a specific bank in the plurality of banks indicates the exclusive use and the usage of the specific bank does not indicate the exclusive use, the control unit moves the specific page to another bank of which the usage indicates the exclusive use and of which the master identifier matches the specific page.
(5) The memory controller according to any one of (2) to (4) described above, in which
each of the plurality of pages includes a plurality of words,
the attribute includes a state indicating whether or not valid word data is stored for each of the plurality of words, and a master identifier indicating a specific master that has accessed the word data last among the plurality of masters in a case where the valid word data is stored, and
when an access to a specific word in the plurality of words occurs, the attribute information management unit updates the state of the specific word and the master identifier.
(6) The memory controller according to (5) described above, in which
when an access to a specific word in the plurality of words occurs, the attribute information management. unit updates the attribute of a specific page to which the specific word belongs among the plurality of pages.
(7) The memory controller according to (6) described above, in which
when an access to a specific word in the plurality of words occurs, in a case where the master identifier of each of all words storing valid word data among words included in a specific page to which the specific word belongs indicates the same master, the attribute information management unit sets the usage of the specific page to the exclusive use.
(8) The memory controller according to any one of (2) to (7) described above, in which
an initial value of the attribute of each of the plurality of pages and the plurality of banks is the shared use.
(9) The memory controller according to any one of (2) to (8) described above, further including a setting register that sets upper limit values of a number of banks of which the usage indicates the shared use and a number of banks of which the usage indicates the exclusive use in the plurality of banks.
(10) The memory controller according to any one of (1) to (9) described above, further including a page conversion table that manages a movement destination page address of a page moved between the plurality of banks among the plurality of pages and performs page address conversion.
(11) The memory controller according to any one of (1) to (10) described above, further including a status register that is an interface that observes and changes the attribute.
(12) A storage device including:
a memory including a plurality of banks each including a plurality of pages;
an attribute information management unit that manages an attribute determined on the basis of a mode in which each of the plurality of pages and the plurality of banks is accessed by a plurality of masters; and
a control unit that moves any of the plurality of pages among the plurality of banks on the basis of the attribute.
(13) A computer system including:
a memory including a plurality of banks each including a plurality of pages;
a plurality of masters that accesses the memory;
an attribute information management unit that manages an attribute determined on the basis of a mode in which each of the plurality of pages and the plurality of banks is accessed by the plurality of masters; and
a control unit that moves any of the plurality of pages among the plurality of banks on the basis of the attribute.

### REFERENCE SIGNS LIST

100 Master
199 Bus
200 Memory controller
210 Attribute management table
220 Page conversion table
230 Status register
240 Setting register
290 Control unit
300 Memory
310 Bank
320 Page
330 Word

1. A memory controller comprising:
an attribute information management unit that manages an attribute determined on a basis of a mode in which, in a memory including a plurality of banks each including a plurality of pages, each of the plurality of pages and the plurality of banks is accessed by a plurality of masters; and
a control unit that moves any of the plurality of pages among the plurality of banks on a basis of the attribute.

2. The memory controller according to claim 1, wherein
the attribute includes usage indicating whether each of the plurality of pages and the plurality of banks is a page or bank for shared use accessed by two or more of the plurality of masters or a page or bank for exclusive use accessed by only one of the plurality of masters, and
the control unit moves any of the plurality of Pages among the plurality of banks so that the usage matches between each of the plurality of pages and each of the plurality of banks.

3. The memory controller according to claim 2, wherein
in a case where the usage of a specific page belonging to a specific bank in the plurality of banks indicates the shared use and the usage of the specific bank does not indicate the shared use, the control unit moves the specific page to another bank of which the usage indicates the shared use.

4. The memory controller according to claim 2, wherein
in a case where the usage of each of the plurality of pages and the plurality of banks indicates the exclusive use, the attribute includes a master identifier of a specific master that has accessed the page or bank last among the plurality of masters, and
in a case where the usage of a specific page belonging to a specific bank in the plurality of banks indicates the exclusive use and the usage of the specific bank does not indicate the exclusive use, the control unit moves the specific page to another bank of which the usage indicates the exclusive use and of which the master identifier matches the specific page.

5. The memory controller according to claim 2, wherein
each of the plurality of pages includes a plurality of words,
the attribute includes a state indicating whether or not valid word data is stored for each of the plurality of words, and a master identifier indicating a specific master that has accessed the word data last among the plurality of masters in a case where the valid word data is stored, and
when an access to a specific word in the plurality of words occurs, the attribute information management unit updates the state of the specific word and the master identifier.

6. The memory controller according to claim 5, wherein
when an access to a specific word in the plurality of words occurs, the attribute information management unit updates the attribute of a specific page to which the specific word belongs among the plurality of pages.

7. The memory controller according to claim 6, wherein
when an access to a specific word in the plurality of words occurs, in a case where the master identifier of each of all words storing valid word data among words included in a specific page to which the specific word belongs indicates a same master, the attribute information management unit sets the usage of the specific page to the exclusive use.

8. The memory controller according to claim 2, wherein
an initial value of the attribute of each of the plurality of pages and the plurality of banks is the shared use.

9. The memory controller according to claim 2, further comprising a setting register that sets upper limit values of a number of banks of which the usage indicates the shared use and a number of banks of which the usage indicates the exclusive use in the plurality of banks.

10. The memory controller according to claim 1, further comprising a page conversion table that manages a movement destination page address of a page moved between the plurality of banks among the plurality of pages and performs page address conversion.

11. The memory controller according to claim 1, further comprising a status register that is an interface that observes and changes the attribute.

12. A storage device comprising:
a memory including a plurality of banks each including a plurality of pages;
an attribute information management unit that manages an attribute determined on a basis of a mode in which each of the plurality of pages and the plurality of banks is accessed by a plurality of masters; and
a control unit that moves any of the plurality of pages among the plurality of banks on a basis of the attribute.

13. A computer system comprising:
a memory including a plurality of banks each including a plurality of pages;
a plurality of masters that accesses the memory;
an attribute information management unit that manages an attribute determined on a basis of a mode in which each of the plurality of pages and the plurality of banks is accessed by the plurality of masters; and
a control unit that moves any of the plurality of pages among the plurality of banks on a basis of the attribute.
